(19) United States
(12) Patent Application Publication
(10) Pub. No.: US 2017/0175953 A1
(43) Pub. Date: Jun. 22, 2017

(54) TUBULAR LIGHTING FIXTURE

(71) Applicant: PHILIPS LIGHTING HOLDING B.V., EINDHOVEN (NL)

(72) Inventors: JACOBUS DINGENIS MACHIEL VAN BOVEN, EINDHOVEN (NL); BARTEL MARINUS VAN DE SLUIS, EINDHOVEN (NL); JOHANNES PETRUS WILHELMUS BAAIJENS, EINDHOVEN (NL)

(21) Appl. No.: 15/118,325

(22) PCT Filed: Jan. 9, 2015
(86) PCT No.: PCT/IB2015/050160

§ 371 Date: Aug. 11, 2016

Related U.S. Application Data
(60) Provisional application No. 61/938,432, filed on Feb. 11, 2014.

(51) Int. Cl. F21K 9/275; F21K 9/65; F21V 21/15; F21S 4/28; F21V 14/02

(52) U.S. Cl. CPC F21K 9/275; F21S 4/28; F21V 14/02; F21V 21/15; F21K 9/65; F21Y 2103/10

(57) ABSTRACT

Disclosed is a lighting fixture including a tubular housing and a cylindrical member that extends within the tubular housing parallel to a longitudinal axis of the tubular housing. A lighting assembly including a strip of light sources may be movably mounted on the surface of the cylindrical member so that the strip of light sources extends parallel to the longitudinal axis. In various embodiments, the lighting assembly is movable about an arc of the surface of the cylindrical member. In various embodiments, the light sources may be LED-based or another type of light source. In some embodiments, one or more lighting fixtures described herein may be used as replacement bulbs in conventional fluorescent light fixtures.

### TECHNICAL FIELD

The present invention is directed generally to controllable lighting fixtures. More particularly, various inventive methods and apparatus disclosed herein relate to lighting fixtures with one or more strips of light sources that are movable within tubular housings.

### BACKGROUND

Fluorescent lighting is used ubiquitously to illuminate various environments. Stores, for example, may have fluorescent lighting installed in aisles to illuminate products on shelves. In some instances, custom lighting fixtures may be built to direct emitted beams of light onto the shelves or portions thereof, e.g., to attract customers' attention to particular products. However, should those shelves move or be replaced with shelves of different sizes, or if it is desired that a different portion of the shelves be illuminated, those custom lighting fixtures may become obsolete. While optical elements could be installed on conventional fluorescent lighting to enable varying nodes of light to be emitted in various directions, such optical elements may be expensive and/or cumbersome to install or use.

Digital lighting technologies, i.e., illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Thus, there is a need in the art to facilitate alteration of nodes of light emitted by an elongate lighting fixture, such an LED-based lighting fixture suitable to replace a conventional fluorescent lighting fixture in various applications.

### SUMMARY

The present disclosure is directed to inventive methods and apparatus for controllable lighting fixtures. For example, a lighting fixture may include a tubular housing with one or more strips of light sources movably mounted therein, to facilitate selection of multiple directions in which lobes of light may be cast.

Generally, in one aspect, an LED-based lighting fixture may include: a tubular housing; a cylindrical member that extends within the tubular housing parallel to a longitudinal axis of the tubular housing; and a lighting assembly including a strip of LED-based light sources. The lighting assembly may be movably mounted within the tubular housing so that the strip of LED-based light sources extends parallel to the longitudinal axis and emits a lobe of light along a normal to a surface of the cylindrical member. The lighting assembly may be movable about at least a portion of an arc of the surface of the cylindrical member.

In various embodiments, the lighting assembly may be a first lighting assembly, the strip of LED-based light sources may be a first strip of LED-based light sources, and the lobe of light may be a first lobe of light. The LED-based lighting fixture may further include a second lighting assembly including a second strip of LED-based light sources. The second lighting assembly may be mounted within the tubular housing so that the second strip of LED-based light sources extends parallel to the first strip of LED-based light sources and emits a second lobe of light along another normal to a surface of the cylindrical member. In various versions, the first lighting assembly is movable about the arc relative to the second lighting assembly. In various versions, the second lighting assembly is mounted on the surface of the cylindrical member at a point along the arc.

In various versions, the second lighting assembly is movably mounted on the surface of the cylindrical member so that it is movable about a second portion of the arc of the surface. In various versions, the first and second portions of the arc at least partially overlap. In various other versions, the first and second portions of the arc do not overlap.

In various embodiments, a central angle between the first and second lighting assemblies is at least 90 degrees. In various versions, the central angle is at least 120 degrees. In various embodiments, the central angle is at least 180 degrees.

In various embodiments, the lighting assembly may further include a printed circuit board movably mounted on the surface of the cylindrical member, wherein the strip of LED-based light sources is mounted on the printed circuit board. In various embodiments, the lighting assembly may further include a plurality of optical elements disposed adjacent the LED-based light sources. In various versions, the plurality of optical elements includes at least one collimator.

In various embodiments, an electric motor may move the lighting assembly along the surface of the cylindrical member about the arc. In various versions, the lighting assembly may further include a controller and a wireless interface. The controller may be configured to operate the electric motor to move the lighting assembly along the surface of the cylindrical member about the arc based on one or more user instructions received at the wireless user interface. In various versions, the wireless interface implements at least one of ZigBee, NFC and WiFi.

In another aspect, a replacement light tube for a lighting fixture configured for use with conventional fluorescent light sources may include: an elongate tubular housing; first and second end caps mounted at opposite ends of the elongate tubular housing, wherein the tubular housing is sized so that the first and second end caps can be mounted in corresponding sockets of the light fixture; a cylindrical member secured to at least one of the first and second end caps and contained within the tubular housing; first and second strips of light sources disposed at different points along an arc defined by a surface of the cylindrical member and extending parallel to a longitudinal axis of the tubular housing, wherein the first and second strips of light sources emit first and second lobes of light along first and second normal to the surface of the cylindrical member; and a controller configured to selectively energize the first and second strips of light sources, individually or simultaneously, based on a received instruction.

In various embodiments, the second strip of LED-based light sources may be movable about the arc relative to the first strip. In various embodiments, a central angle between the first and second strips of light sources is at least 45 degrees. In various embodiments, the replacement light tube may further include a third strip of LED-based light sources disposed at another point along the arc defined by the surface of the cylindrical member and extending parallel to a longitudinal axis of the tubular housing. The controller may be further configured to selectively energize the third strips of light sources, individually or simultaneously with one or both of the first and second strips, based on the received instruction, such that the third strip of light sources emits a third lobe of light along a third normal to the surface of the cylindrical member.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs

The term “light source” should be understood to refer to any one or more of a variety of radiation sources, including, but not limited to, LED-based sources (including one or more LEDs as defined above).

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of approximately 700 degrees K (typically considered the first visible to the human eye) to over 10,000 degrees K; white light generally is perceived at color temperatures above 1500-2000 degrees K.

The term “lighting unit” or “lighting assembly” is used herein to refer to an apparatus including one or more light sources of same or different types. A given lighting assembly may have any one of a variety of mounting arrangements for the light source(s), enclosure/housing arrangements and shapes, and/or electrical and mechanical connection configurations. Additionally, a given lighting assembly optionally may be associated with (e.g., include, be coupled to and/or packaged together with) various other components (e.g., control circuitry) relating to the operation of the light source(s). An “LED-based lighting assembly” refers to a lighting assembly that includes one or more LED-based light sources as discussed above, alone or in combination with other non LED-based light sources. A “multi-channel” lighting assembly refers to an LED-based or non LED-based lighting assembly that includes at least two light sources configured to respectively generate different spectrums of radiation, wherein each different source spectrum may be referred to as a “channel” of the multi-channel lighting fixture.

As used herein, a “strip of light sources” includes a lighting assembly with two or more light sources of various types, including but not limited to LEDs, arranged substantially in a linear direction. In various embodiments, a strip of LED-based light sources maybe mounted on a printed circuit board (PCB). In some embodiments, each light source may be controllable individually. In other embodiments, light sources of a strip may be controlled collectively. Light sources of a strip may collectively emit light in a particular direction, depending for instance on a direction in which the strip is oriented. Such light may be cast across a particular angle, depending on characteristics of the light sources, optical elements such as collimators associated with the light sources, and so forth. In some instances, light cast by a light strip across a particular angle in a particular direction may be referred to as a “lobe.” In embodiments where LEDs are used, a strip of light sources may be capable of emitting lighting various selected properties, including but not limited to hue, saturation, brightness, intensity, and so forth.

The term “lighting fixture” or “luminaire” is used herein to refer to an implementation or arrangement of one or more lighting assemblies in a particular form factor, assembly, or package within a housing or enclosure.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an example lighting fixture, in accordance with various embodiments.

FIGS. 2 and 3 illustrate an example of how disclosed lighting fixtures may be adjusted so that lobes of light they emit may illuminate various areas, in accordance with various embodiments.

FIG. 4 depicts another example lighting fixture, in accordance with various embodiments.

FIG. 5 depicts yet another example lighting fixture, in accordance with various embodiments.

FIG. 6 depicts yet another example lighting fixture, in accordance with various embodiments.

### DETAILED DESCRIPTION

Fluorescent lighting tubes are used ubiquitously to illuminate various environments. Custom lighting fixtures may be built to direct lobes of light emitted by lighting tubes onto shelves or portions thereof. However, should those shelves move or be replaced with shelves of different sizes, or if it is desired that a different portion of the shelves be illuminated, those custom lighting fixtures may become obsolete. Optical elements for resizing and/or redirecting lobes of light emitted by the tubular lighting fixtures may be expensive and/or cumbersome to install or use. Thus, Applicants have recognized and appreciated that it would be beneficial to provide tubular lighting fixtures that are adjustable, so that lobes of light they emit can be resized and/or redirected in multiple directions.

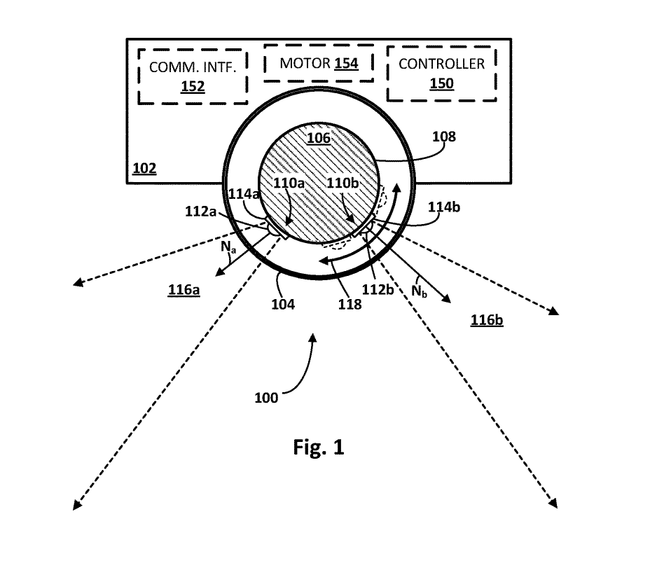

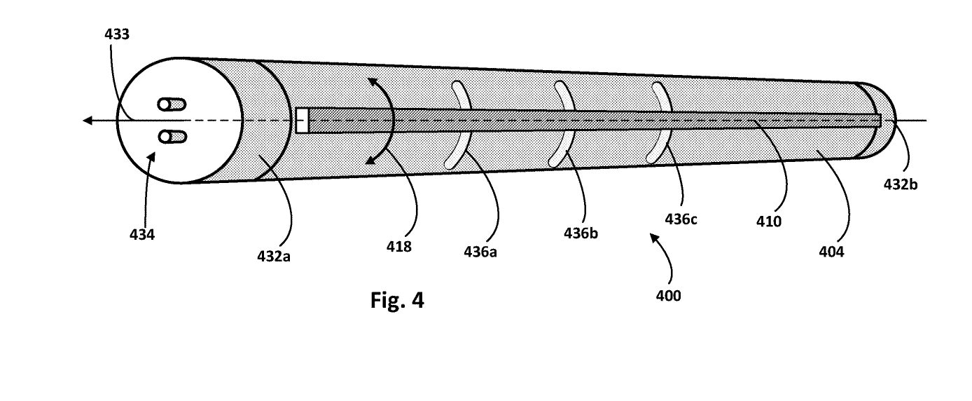

In view of the foregoing, various embodiments and implementations of the present invention are directed to lighting fixtures with tubular housings and one or more strips of light sources that are adjustable to cast lobes of light in different directions. Referring to FIG. 1, a lighting fixture 100 configured with selected aspects of the present disclosure is depicted mounted in a lighting fixture 102. In some embodiments, the lighting fixture 102 may be a conventional fluorescent lighting fixture. The lighting fixture 100 may include a tubular housing 104 and a cylindrical member 106 mounted within tubular housing 104. Although not shown in FIG. 1, lighting fixture 100 may include end caps (see FIG. 4) at each end. Tubular housing 104 and the end caps may be sized such that lighting fixture 100 may be installed in fluorescent lighting fixture 102, e.g., as a replacement for conventional fluorescent tubes.

Cylindrical member 106 may include a surface 108. In various embodiments, surface 108 may be generally (but not necessarily perfectly) circular in cross section, as is the case in FIG. 1, though this is not required. One or more light assemblies may be mounted on or near surface 108. For instance, in FIG. 1, first and second light assemblies 110a and 110b are mounted on surface 108. In various embodiments, each lighting assembly (generically referred to by 110) may include a strip of light sources 112 mounted on a substrate such as a printed circuit board 114. Strips of light sources 112a and 112b may emit respective lobes of light, 116a and 116b, along normals to surface 108, e.g., along lines Nₐ and N_{b}. In various embodiments, strips of light sources 112a and 112b may extend parallel to a longitudinal axis of tubular housing 104 (which extends into the page in FIG. 1).

In various embodiments, one or more of the light assemblies 110 may be movably mounted on surface 108. For instance, in FIG. 1, second lighting assembly 110b is movably mounted on surface 108 such that it can be moved about at least a portion of an arc 118 defined by surface 108 to various positions relative to first lighting assembly 110a, as depicted in phantom in FIG. 1. In this manner, the node 116b of light emitted by second light strip 112b may be pointed in multiple directions as desired. In various embodiments, optical elements such as lenses or collimators may be employ at or near light sources to control dimensions of lobes of light 116a and 116b.

Although not depicted in FIG. 1, in some embodiments, first lighting assembly 110a may also be movable, e.g., about another arc defined be surface 108. In some embodiments, the arc about which first lighting assembly 110a may be moved may or may not overlap with arc 118. In some embodiments where the arcs overlap, printed circuit boards 114a and 114b may include appropriate spaces to allow passage of portions of the other. In other such embodiments, one of first lighting assembly 110a and second lighting assembly 110b may pass over or under the other.

A central angle between first lighting assembly 110a and second lighting assembly 110b, which may be an angle subtended by an arc (not depicted) along surface 108 between first lighting assembly 110a and second lighting assembly 110b, may vary depending on a position of first lighting assembly 110a or second lighting assembly 110b. In various embodiments, second lighting assembly 110a may have sufficient freedom of movement along at least a portion of arc 118 that the central angle between first lighting assembly 110a and second lighting assembly 110b may be least 120 degrees and/or at least at least 180 degrees.

In some embodiments, a controller 150 may be operably coupled with a communication interface 152 (designated “COMM. INTF.” in FIG. 1) and/or an electric motor 154. Electric motor 154 may be configured to move second lighting assembly 110b (and first lighting assembly 110a if it is movable) about arc 118 in various ways. For example, electric motor 154 may be operably coupled with second lighting assembly 110b, e.g., via a drive train (not depicted), at one or more points within cylindrical member 106. In some embodiments, one or more slots (see FIG. 4) may be formed in surface 108 along arc 118. One or more components of an internal drive train may be coupled to an underside of printed circuit board 114b through such a slot, which may enable the drive train to move second lighting assembly 110b along arc 118.

In various embodiments, controller 150 may be configured to operate electric motor 154 based on a user instruction, e.g., received at communication interface 152. In various embodiments, communication interface 152 may be configured to receive data from a remote computing device such as a tablet computer, smart phone, lap top, set top box, desktop computer, and so forth, using various wireless technologies. These technologies may include but are not limited to ZigBee, near field communication (“NFC”) and WiFi. In other embodiments, second lighting assembly 110b and/or first lighting assembly 110a may be movable about arc 118 manually, e.g., by a user actuating one or more knobs, levers or other physical components.

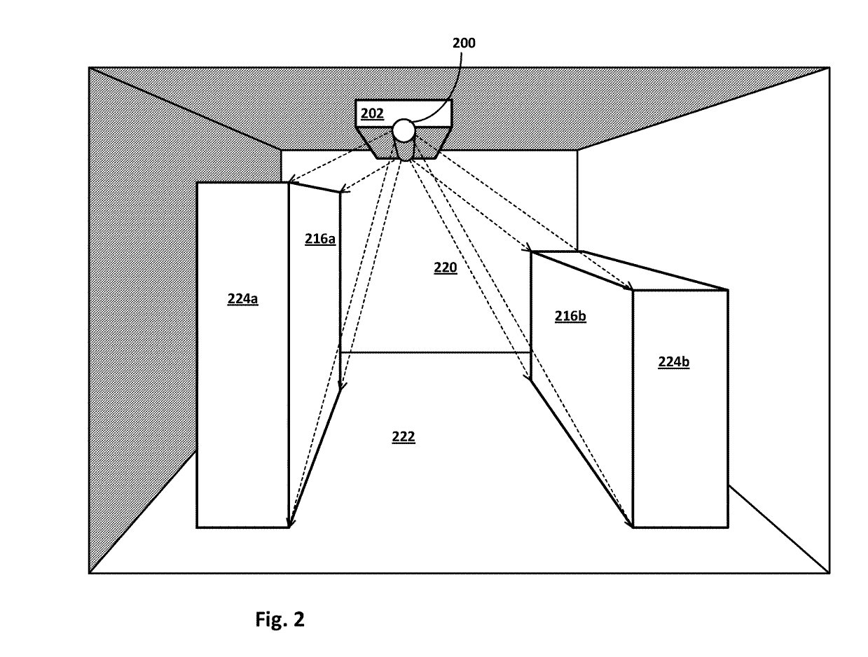

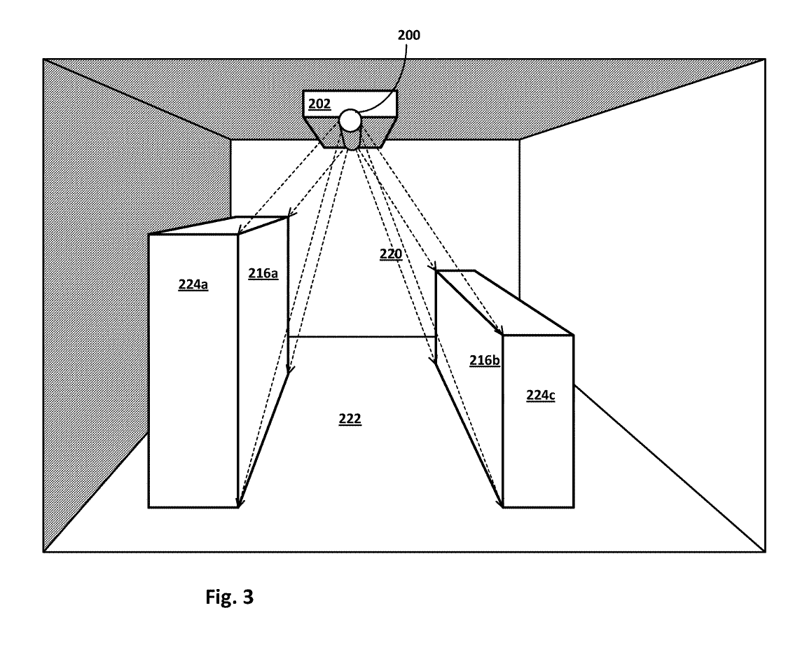

FIGS. 2 and 3 depict one non-limiting example in which lighting fixtures configured with selected aspects of the present disclosure may be used. An environment 220 includes an aisle 222 and two shelves, 224a and 224b. A lighting fixture 200 equipped with selected aspects of the present disclosure has been installed into a fluorescent lighting fixture 202. In FIG. 2, a first lobe of light 216a is directed at first shelf 224a, and a second lobe of light 216b is directed at second shelf 224b. In FIG. 3, second shelf 224b has been replaced with a third shelf 224c. Third shelf 224c is shorter than second shelf 224b, and is positioned closer to the center of environment 220 than second shelf 224b was. Accordingly, at least one strip of light (not depicted in FIGS. 2 and 3) within lighting fixture 200 has been adjusted so that second lobe of light 216b is now directed in a different angle, namely, at third shelf 224c.

Additionally or alternatively, one or more light assemblies may be adjustable so that first lobe of light 216a and/or second lobe of light 216b have other properties and/or illuminate shelves in other ways. For instance, both lobes could be pointed at different portions of a single shelf. In some embodiments, a plurality of light assemblies, each emitting a different color, may be pointed along a surface, e.g., so that each shelf is illuminated with a different color. Thus, for instance, a rainbow could be created on a surface, with each color corresponding to a lobe of light emitted by a strip of light sources of a lighting assembly.

FIG. 4 is a perspective view of a lighting fixture 400 similar to lighting fixture 100 of FIG. 1. End caps 432a and 432b are visible on opposite sides of an elongate tubular housing 404 along its longitudinal axis 433. Electrical components 434 are visible on end cap 432a (the same may or may not be present on end cap 432b) to connect lighting fixture 400 to corresponding electrical components of, for instance, a fluorescent lighting fixture 102 or 202. One or more slots 436a-c (can be more or less than three) may be formed in surface 408 along arc 418. This may permit portions of an internal drive train (not depicted) to move a lighting assembly 410 along those slots. Moving lighting assembly 410 in this manner may permit a lobe of light emitted by lighting assembly 410 to be pointed in multiple directions. FIG. 4 is just one example of how a lighting fixture may be configured to permit movement of one or more light assemblies about an arc. It should be understood that other configurations may be employed without departing from the present disclosure.

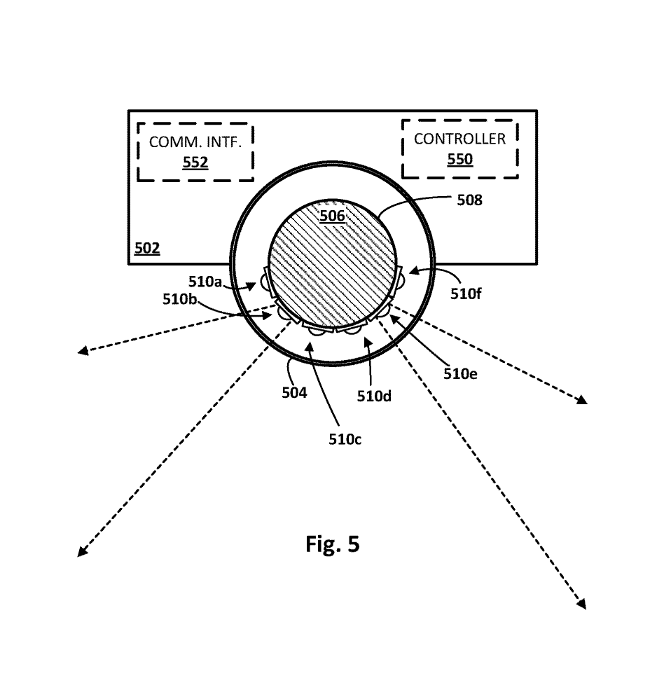

FIG. 5 depicts an alternative embodiment of a lighting fixture 500. A plurality of light assemblies 510a-f may be mounted on surface 508 of cylindrical member 506 at various positions around the circumference of cylindrical member 506. A controller 550 may be operably coupled with a communication interface 552 (designated “COMM. INTF.” in FIG. 5). Controller 550 may be configured to selectively energize one or more strips of light sources 512a-f associated with one or more the plurality of light assemblies 510a-f, e.g., to cause lobes of light to be cast in different directions. In some instances, controller 550 may energize strips individually and/or independently of other strips. In some embodiments, controller 550 may energize two or more strips simultaneously. In various embodiments, controller 550 may selectively illuminate one or more of strips of light sources 512a-f based on a user instruction, e.g., received at communication interface 552. In various embodiments, and similar to the embodiment of FIG. 1, communication interface 552 may be configured to receive data from a remote computing device such as a tablet computer, smart phone, lap top, set top box, desktop computer, and so forth, using various wireless technologies. These technologies may include but are not limited to ZigBee, NFC and WiFi.

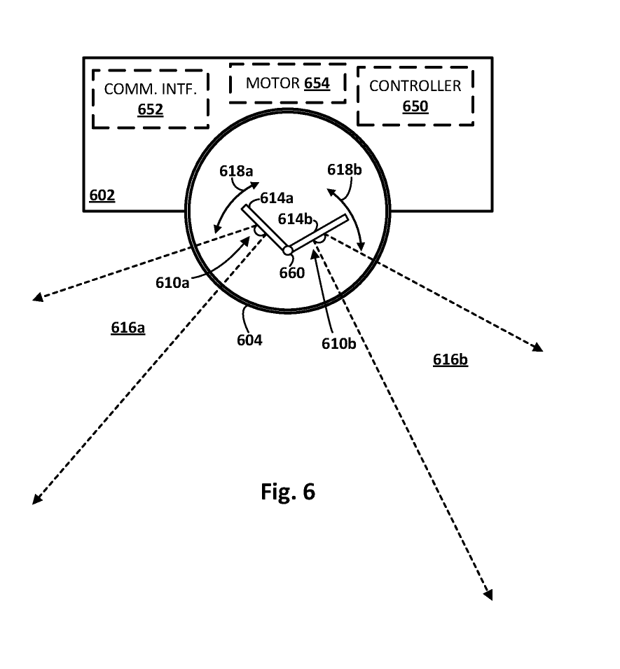

FIG. 6 depicts an alternative embodiment of a lighting fixture 600. Instead of a cylindrical member about which light assemblies may be moved, light assemblies 610a and 610b may include printed circuit boards 614a and 614b, respectively, that are connected to each other via a hinge 660. This may permit printed circuit boards 614a and 614b to be moved along arcs 618a and 618b, respectively, to redirect lobes of light 616a and 616b in various directions. As was the case with FIG. 1, lighting fixture 600 may include a controller 650 operably coupled with a communication interface 652 and an electric motor 654. In response to user commands received at communication interface 652, controller 650 may cause electrical motor 654 to rotate one or both of printed circuit boards 614a and 614b in various directions to achieve the desired lighting effects (e.g., illumination of shelves). In other embodiments, one or both of printed circuit boards 614a and 614b may be movable manually about arcs 618a and 618b, respectively, e.g., by a user actuating one or more knobs, levers or other physical components.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Reference numerals appearing between parentheses in the claims, if any, are provided merely for convenience and should not be construed as limiting the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An LED-based lighting fixture, comprising:
a tubular housing;
a cylindrical member that extends within the tubular housing parallel to a longitudinal axis of the tubular housing; and
a lighting assembly including a strip of LED-based light sources, the lighting assembly movably mounted within the tubular housing so that the strip of LED-based light sources extends parallel to the longitudinal axis and emits a lobe of light along a normal to a surface of the cylindrical member, wherein the lighting assembly is movable about at least a portion of an arc of the surface of the cylindrical member.

2. The LED-based lighting fixture of claim 1, wherein the lighting assembly is a first lighting assembly, the strip of LED-based light sources is a first strip of LED-based light sources, the lobe of light is a first lobe of light, and the LED-based lighting fixture further comprises a second lighting assembly including a second strip of LED-based light sources, the second lighting assembly mounted within the tubular housing so that the second strip of LED-based light sources extends parallel to the first strip of LED-based light sources and emits a second lobe of light along another normal to a surface of the cylindrical member.

3. The LED-based lighting fixture of claim 2, wherein the first lighting assembly is movable about the arc relative to the second lighting assembly.

4. The LED-based lighting fixture of claim 3, wherein the second lighting assembly is mounted on the surface of the cylindrical member at a point along the arc.

5. The LED-based lighting fixture of claim 2, wherein the second lighting assembly is movably mounted on the surface of the cylindrical member so that it is movable about a second portion of the arc of the surface.

6. The LED-based lighting fixture of claim 5, wherein the first and second portions of the arc at least partially overlap.

7. The LED-based lighting fixture of claim 5, wherein the first and second portions of the arc do not overlap.

8. The LED-based lighting fixture of claim 2, wherein a central angle between the first and second light assemblies is at least 90 degrees.

9. The LED-based lighting fixture of claim 8, wherein the central angle is at least 120 degrees.

10. The LED-based lighting fixture of claim 9, wherein the central angle is at least 180 degrees.

11. The LED-based lighting fixture of claim 1, wherein the lighting assembly further comprises a printed circuit board movably mounted on the surface of the cylindrical member, wherein the strip of LED-based light sources is mounted on the printed circuit board.

12. The LED-based lighting fixture of claim 1, wherein the lighting assembly further comprises a plurality of optical elements disposed adjacent the LED-based light sources.

13. The LED-based lighting fixture of claim 12, wherein the plurality of optical elements includes at least one collimator.

14. The LED-based lighting fixture of claim 1, further comprising an electric motor to move the lighting assembly along the surface of the cylindrical member about the arc.

15. The LED-based lighting fixture of claim 14, further comprising a controller and a wireless interface, the controller configured to operate the electric motor to move the lighting assembly along the surface of the cylindrical member about the arc based on one or more user instructions received at the wireless user interface.

16. The LED-based lighting fixture of claim 15, wherein the wireless interface implements at least one of ZigBee, NFC and WiFi.

17. A replacement light tube for a fluorescent light fixture, comprising:
an elongate tubular housing;
first and second end caps mounted at opposite ends of the elongate tubular housing, wherein the tubular housing is sized so that the first and second end caps can be mounted in corresponding sockets of the fluorescent light fixture;
a cylindrical member secured to at least one of the first and second end caps and contained within the tubular housing;
first and second strips of light sources disposed at different points along an arc defined by a surface of the cylindrical member and extending parallel to a longitudinal axis of the tubular housing, wherein the first and second strips of light sources emit first and second lobes of light along first and second normal to the surface of the cylindrical member; and
a controller configured to selectively energize the first and second strips of light sources, individually or simultaneously, based on a received instructionₛ
wherein the second strip of LED-based light sources is movable about the arc relative to the first strip.

18. (canceled)

19. The replacement light tube of claim 17, wherein a central angle between the first and second strips of light sources is at least 45 degrees.

20. The replacement light tube of claim 17, further comprising a third strip of LED-based light sources disposed at another point along the arc defined by the surface of the cylindrical member and extending parallel to a longitudinal axis of the tubular housing, wherein the controller is further configured to selectively energize the third strips of light sources, individually or simultaneously with one or both of the first and second strips, based on the received instruction, such that the third strip of light sources emits a third lobe of light along a third normal to the surface of the cylindrical member.
